(19) United States
(12) Patent Application Publication
(10) Pub. No.: US 2004/0087455 A1
(43) Pub. Date: May 6, 2004

(54) Deposition of protective coatings on substrate surfaces

(76) Inventors: Richard J. DeGroot, White Lake, MI (US); Ronald L. Shubkin, Baton Rouge, LA (US); Dov Shellef, Great Neck, NY (US)

Correspondence Address: HENRY NAYLOR, KEAN, MILLER, HAWTHORNE, D'ARMOND, MCCOWAN & JAMAN, P.O BOX 3513, BATON ROUGE, LA, 70821-3513, US

(21) Appl. No.: 10/283,712

(22) Filed: Oct. 30, 2002

(51) Int. Cl. C11D 1/00

(52) U.S. Cl. 510/175

(57) ABSTRACT

A solvent system for depositing a coating material onto a solid substrate surface, which solvent system is comprised of at least two organic solvents wherein at least one of the solvents has a substantially different vapor pressure that at least one other solvent in the solvent system. This invention also relates to a method for depositing thin films on substrate surfaces using a solvent system comprised of a blend of at least two organic solvents having substantially different vapor pressures. In a preferred embodiment the solvent system is comprised of effective amounts of n-propyl bromide and 1,1,1,3,3-pentafluorobutane.

### FIELD OF THE INVENTION

The present invention relates to the deposition of thin films on substrate surfaces using a solvent system comprised of a blend of at least two organic solvents having substantially different vapor pressures. In a preferred embodiment the solvent system is comprised of effective amounts of n-propyl bromide and 1,1,1,3,3-pentafluorobutane.

### BACKGROUND OF THE INVENTION

Thin protective films and coatings are applied to myriad articles of manufacture. These substrates range from a wide variety of metal components to plastic and elastomeric components. The protective coatings can be temporary coatings such as an oil coating to prevent oxidation of the component or a relatively thin coating of a lubricant to reduce friction. The protective coatings can also be of a permanent nature, such as a coating of ink, paint or varnish.

Many of these coatings are applied using an inert solvent carrier that deposits a layer of coating material on a substrate to be coated. The solvent carrier evaporates, leaving the desired coating on the substrate. In such systems, the solvent acts to “wet” the substrate. That is, it spreads across the surface of the substrate, applying as uniform a coating as possible on the substrate sufrace. Thus, it is desirable to use a solvent system with the greatest degree of spreading, or wettability, as possible. The greater the degree of wettability the less solvent is needed to apply a substantially uniform coating onto the surface of a substrate.

While various solvents and solvent systems are in commercial use today, there still remains a need in the art for solvent systems having improved wettability properties.

### SUMMARY OF THE INVENTION

In accordance with the present invention, there is provided a method for applying a coating to a solid substrate surface, which method comprises:

preparing a mixture of at least two organic solvents wherein the vapor pressure of at least one of the solvents is substantially different than that of at least one of the other solvents;

blending with said solvent mixture an effective amount of coating material to be coated onto said solid substrate surface;

applying said blend of solvent mixture and coating material to the solid substrate surface; and

evaporating said solvent mixture, thereby leaving a substantially uniform coating of said coating material on said substrate surface.

In a preferred embodiment one of the solvents has a vapor pressure of at least about 80 mmHg different than that of at least one of the other solvents.

In another preferred embodiment the solvent mixture is comprised of an effective amount of n-propyl bromide and a hydrofluorocarbon solvent.

In still another preferred embodiment of the present invention the hydrofluorocarbon solvent is selected from the group consisting of 1,1,1,3,3-pentafluorobutane, 2,3-dihydrodecafluoropentane, and 1,1-dichloro-1-fluoroethane.

In another preferred embodiment the solvent mixture is comprised of an effective amount of each of n-propyl bromide and 1,1,1,3,3-pentafluorobutane.

In still another preferred embodiment the substrate surface is a glass, ceramic, metallic or polymeric surface and the coating material is a protective oil or lubricant.

In another preferred embodiment the coating material is an ink, paint or varnish.

In yet another preferred embodiment of the present invention the coating material is an adhesive.

In another preferred embodiment the substrate to be coated is a hypodermic needle and the coating material is a lubricant, preferably a silicone compound.

### BRIEF DESCRIPTION OF THE FIGURES

FIG. 1 is a plot of the percent n-propyl bromide versus drop diameter in inches for Example 1 hereof.

FIG. 2 is a plot of percent n-propyl bromide versus increase in area covered for Example 1 hereof.

FIG. 3 is a plot of the evaporation rate of various mixtures of n-propyl bromide and 1,1,1,3,3-pentafluorobutane for Example 2 hereof.

FIG. 4 is a plot of Vapor Liquid Equilibrium (VLE) data obtained in Example 3 hereof.

### DETAILED DESCRIPTION OF THE INVENTION

The present invention, in the broadest sense, relates to a solvent system effective for depositing a thin film, or coating, onto a solid surface. The solvent system is comprised of effective amounts of at least two organic solvents, wherein at least one of the solvents has a substantially different vapor pressure than at least one of the other solvents and wherein none of the solvents has a vapor pressure less than about 10 mmHg at 20° C. By substantially different vapor pressure we mean that the difference in vapor pressure of at least one of the solvents in the mixture will be at least about 80 mmHg, preferably at least about 90 mmHg, and more preferably at least about 100 mmHg higher or lower than that of at least one other solvent in the mixture. The difference in vapor pressure will be at use temperatures, that is at the temperature at which a given coating material plus solvent system is deposited onto a substrate surface. It is preferred that the solvent system be comprised of two organic solvents one of which is n-propyl bromide (nPB) and one or more of the following hydrofluorocarbon solvent. It is preferred that the hydrofluorocabon solvent be selected from the C₂-C₅ straight or branched hydrofluorocarbons wherein at least one, but not all, of the hydrogen atoms is substituted with a fluorine atom and wherein a primary hydrogen atom can be substituted with a C₁ to C₃ alkoxy group, preferably methoxy or ethoxy. It is preferred that the hydrofluorocarbon contain 4 carbon atoms. It is also preferred that the hydrofluorocarbon be selected from the group consisting of 1,1,1,3,3-pentafluorobutane; 2,3-dihydrodecafluoropentane; 1,1-dichloro-1-fluoroethane; methoxy-nonafluorobutane; ethoxy-nonafluorobutane; methoxy-nonafluorobutane; and ethoxy-nonafluoroisobutane. It is more preferred that the hydrofluorocarbon be selected from 1,1,1,3,3-pentafluorobutane; 2,3-dihydrodecafluoropentane; and 1,1-dichloro-1-fluoroethane; most preferably 1,1,1,3,3-pentafluorobutane.

It is also understood that one or more additional solvents can be added to modify this system. Such solvents can include but are not limited to alcohols, ethers, alkenes, chlorinated alkenes and flouronated solvents. A blend of organic solvents wherein one of them has a substantially different vapor pressure than at least one of the other solvents, particularly these two solvents, exhibits unexpected properties when compared with each of the solvents alone. That is, a synergistic and unexpected relationship exists between such solvents. In other words, the two solvents together produce combined properties greater than the average sum of their separate properties. For example, the ability of a blend of these two solvents to wet a surface is superior to that of either of the individual solvents. Also, a blend of these two solvents has an evaporation rate greater than the evaporation rate of each of the solvents. The wettablility of a blend of nPB and HFC365 has a wettable surface area 4 times greater than each of the individual solvent components. It will be understood that the terms mix and blend are used interchangeably herein.

Any suitable solid surface can be coated in accordance with this invention. Non-limiting examples of such solid surfaces include glass, ceramic, metallic and polymeric.

The present invention also relates to a coating composition comprised of a mixture of two or more organic solvents wherein the vapor pressure of at least two of the solvents is at least about 80 mm different than any of the other solvents, and an effective amount of a coating material. The preferred solvent system will be comprised of n-propyl bromide and 1,1,1,3,3-pentafluorobutane in amounts effective for use in the deposition of thin films and coatings on solid substrate surfaces. An effective ratio of each component to the other is chosen depending on the intended use of the coating composition. In general, the solvent system of the present invention will be comprised of about 5 to 95 wt. % n-propyl bromide and from about 95 to about 5 wt. % hydrofluorocarbon solvent, preferably from about 20 to 80 wt. % n-propyl bromide and from about 80 to about 20 wt. % hydrofluorocarbon solvent, more preferably from about 40 to 60 wt. % n-propyl bromide and from about 60 to about 40 wt. % hydrofluorocarbon solvent, and most preferably 50 wt. % of each.

As previously mentioned the ratio of one solvent to the other is dependent on the intended use of the blend. For example, if the composition is to be used to deposit a protective layer of mineral oil on the surface of a solid substrate, then it is preferred that the ratio of n-propyl bromide to 1,1,1,3,3-pentafluorobutane be about 60% or greater n-propyl bromide and 40% or less 1,1,1,3,3-pentafluorobutane. If a layer of silicone oil is being deposited, as a lubricant, then it is preferred that the ratio of n-propyl bromide to 1,1,1,3,3-pentafluorobutane be 40% or greater n-propyl bromide and 60% or less 1,1,1,3,3-pentafluorobutane.

1,1,1,3,3-pentafluorobutane, which as a boiling point of approximately 40° C. at atmospheric pressure, is particularly advantageous for blending with n-propyl bromide from an environmental point of view since it has a substantially zero destructive potential towards ozone.

Various additives can optionally be present in the compositions of the present invention. Non-limiting examples of such additives include acid acceptors, metal passivators, stabilizing agents, surface-active agents as well as any other additive for the intended use of the blend composition. This makes it possible to improve the behavior of the compositions of the present invention during use. The nature and amount of such additives that are used is dependent on the use envisaged, which is within the ordinary skill of those in the art. As a general rule, the amount of additives used in the compositions according to the present invention does not exceed about 20% of the weight of the final composition, most often not more than about 10 wt. %.

Because n-propyl bromide can hydrolyze or dehydrohalogenate to form hydrogen bromide, it is preferred that one of the additives be an acid acceptor. More preferably, an epoxide is used for this purpose. Non-limiting examples of suitable epoxides include butylene oxide, propylene oxide, epichlorohydrin, cyclohexene oxide, pentene oxide and cyclopentene oxide. If used, epoxides will normally be present in the range from about 0.1 wt. % to 2.0 wt. %, preferably from about 0.25 wt % to 1.5 wt. %.

Ethers may be used as metal passivators in the blend formulations of the present invention. Non-limiting examples of such ethers include 1,2-dimethoxymethane, 1,4-dioxane, 1,3-dioxolane, diethyl ether, diisopropyl ether and trioxane. Ethers may be used singly or in combination, preferably in amounts of about 1 wt. % to 5 wt. %.

Nitroalkanes may also be used in the blend formulations of the present invention as metal passivators. Non-limiting examples include nitromethane, nitroethane, 1-nitropropane and 2-nitropropane. Nitroalkanes may be used singly or in combination, preferably in amounts of about 0.1 wt. % to 2 wt. %.

Other additives may also be included as stabilizers or performance enhancers in the formulation of blends of the present invention. In particular, certain amines, nitriles and alcohols may be used. Non-limiting examples of suitable amines include hexylamine, isohexylamine, octylamine, isooctylamine, dipropylamine, diisopropylamine, dibutylamine, diisobutylamine, tripropylamine, triisopropylamine, and N,N-dimethylcyclohexylamine. Non-limiting examples of suitable nitriles include acetonitrile, propionitrile, and butyronitrile. Non-limiting examples of suitable alcohols include n-propanol, isopropanol, n-butanol, isobutanol and tert.-butanol.

The solvent mixture of the present invention is generally used by blending it with the coating material to be applied to the substrate surface by any conventional mixing or blending technique used in the art. Any suitable coating material that is known in the art for being applied to a substrate surface with use of an organic solvent can be used in the practice of the present invention. Non-limiting examples of such coating materials include protective oils; lubricants, including oils and silicones; inks; paints, and varnishes. It is preferred that the coating material be substantially soluble in the solvent mixture of the present invention, although coating materials that are dispersible may also be used.

The amount of coating material used in relation to the amount of solvent mixture will depend on such things as the application process, desired coating thickness, maximum wetablility of the mixture, and solubility of the coating in the solvent mixture It is preferred that an effective amount of solvent mixture will be used. By effective amount we mean that minimum amount needed to dissolve or disperse the coating material, to a suitable degree, first in the solvent mixture then on the surface of the substrate to produce a substantially uniform coating. An effective amount will typically be from about 0.5 wt. % to about 50 wt. %, or more, depending on the coating material and its intended application.

It has been discovered, by the inventors hereof, that the solvent mixture of the present invention meets the desired characteristics for a coating carrier system for a variety of substrates. More particularly, the solvent mixture of the present invention has the following characteristics: (1) it is substantially stabilized against; a) free acids that may result from oxidation of the mixture in the presence of air; b) from hydrolysis of the mixture in the presence of water; and c) from pyrolysis of the mixture under the influence of high temperatures; (2) it is substantially non-flammable and non-corrosive; (3) the various components of the solvent mixture are free from regulation by the U.S. Clean Air Act; and (4) none of the various components of the solvent mixture are known cancer causing agents (i.e., the various components are not listed by N.T.I., I.A.R.C. and California Proposition 65, nor are they regulated by OSHA). In addition, the solvent mixture of the present invention has an evaporation rate greater than that of each of the two individual components. This ensures rapid drying which is essential to any economical coating process.

This increased evaporation rate has other advantages as well, such as when the solvent mixture is used to deposit a thin film of silicone oil on a hypodermic needle to minimize pain. One problem typically encountered when depositing silicone oil onto a hypodermic needle is the undesirable formation of a drop of silicone oil at the end of the needle due to pooling of the solvent at the tip because of relatively slow evaporation of the solvent. Rapid drying of the deposition composition will help to prevent such a drop of silicone oil from forming at the tip. The solvent system of the present invention also unexpectedly exhibits superior spreadability when compared to n-propyl bromide or 1,1,1,3,3-pentafluorobutane alone. This helps ensure a thin uniform film during deposition, which also helps prevent the formation of a drop of silicone oil at the end of the hypodermic needle being treated.

The solvent mixtures of the present invention can also be used for various cleaning applications. Non-limiting examples of cleaning applications suitable for the solvent mixtures include their use in degreasing applications, in cold cleaning, in hand wipes, in aerosols and sprays, and in line flushing (refrigeration coils, oxygen lines, etc.). They can also be used to clean substrates such as electronic circuit boards, polymeric substrates including plastics, elastomers, and movie film.

n-Propyl bromide is commercially available from a variety of sources. n-Propyl bromide can also be readily synthesized using known synthetic procedures. For example, it can be prepared from the reaction of alcohols with either inorganic acid bromides or with hydrogen bromide. (see, e.g., Carl R. Noller, Textbook of Organic Chemistry. Ch6:81 (1956), the teaching of which is incorporated herein by reference).

Mixtures of n-propyl bromide and 1,1,1,3,3-pentafluorobutane build on each other's strengths while limiting or eliminating the weaknesses of each solvent. In applications where n-propyl bromide is too aggressive in its solvating characteristics, 1,1,1,3,3-pentafluorobutane will moderate this behavior. While 1,1,1,3,3-pentafluorobutane is flammable, blends of n-propyl bromide and 1,1,1,3,3-pentafluorobutane are non-flammable. Also, very rapid drying can be achieved because it has unexpectedly been found that mixtures of the two solvents volatilize faster then either solvent alone.

The invention will be described in greater detail by way of specific examples. The following examples are offered for illustrative purposes, and are intended neither to limit nor to define the invention in any manner.

### EXAMPLE 1

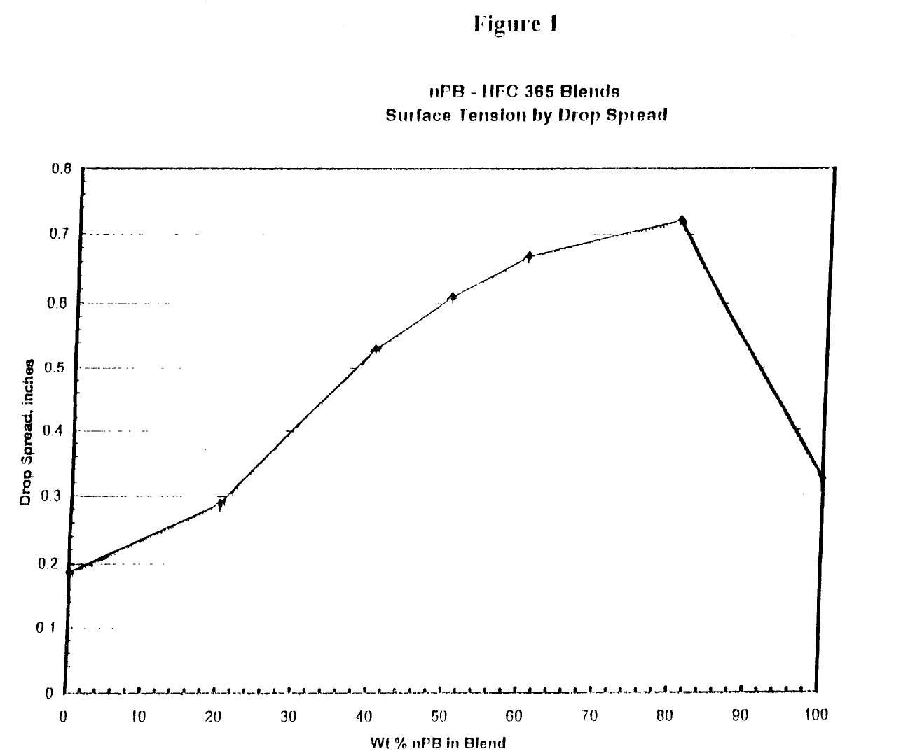

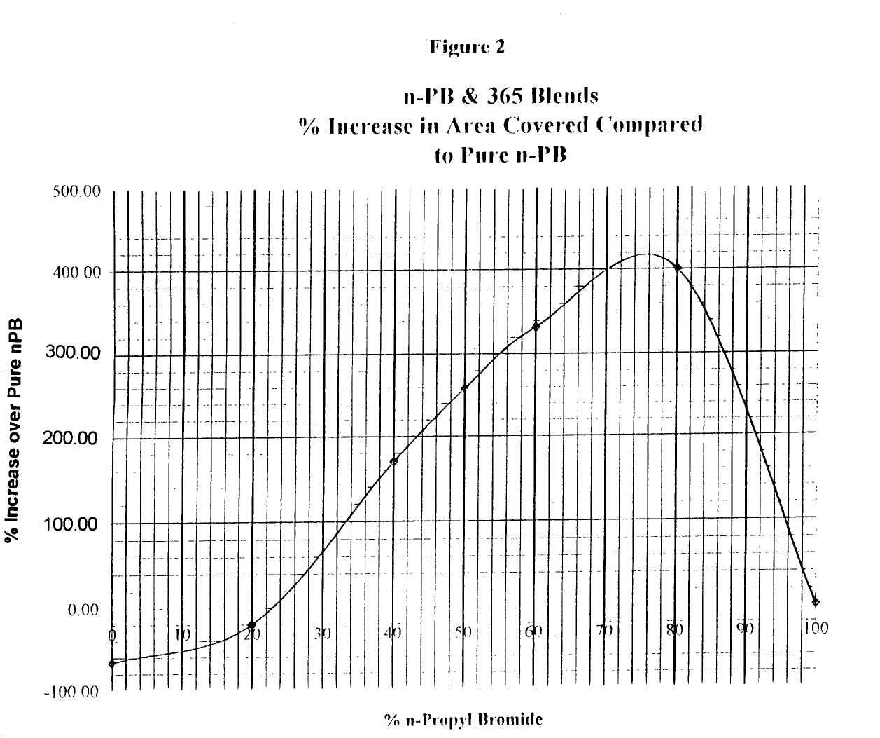

The spreadability of various blends of n-propyl bromide (nPB) and 1,1,1,3,3-pentafluorobutane (HFC365) was measured by drop size experiments. One drop from a syringe needle of each blend was applied to a clean cold rolled steel surface. The diameter of the drop spread on the surface of the steel was measured. Table 1 below and FIGS. 1 and 2 hereof, show the results of these experiments.

TABLE 1

| | | | % Area Increase |
|---|---|---|---|
| | Diameter | | over 100% |
| % nPB | Inches | Area (sq.inches) | nPB |
| 100 | 0.321 | 0.0809 | 0.00 |
| 80 | 0.718 | 0.4049 | 400.31 |
| 60 | 0.667 | 0.3494 | 331.76 |
| 50 | 0.607 | 0.2894 | 257.58 |
| 40 | 0.527 | 0.2181 | 169.53 |
| 20 | 0.286 | 0.0642 | −20.62 |
| 0 | 0.185 | 0.0269 | −66.79 |

### EXAMPLE 2

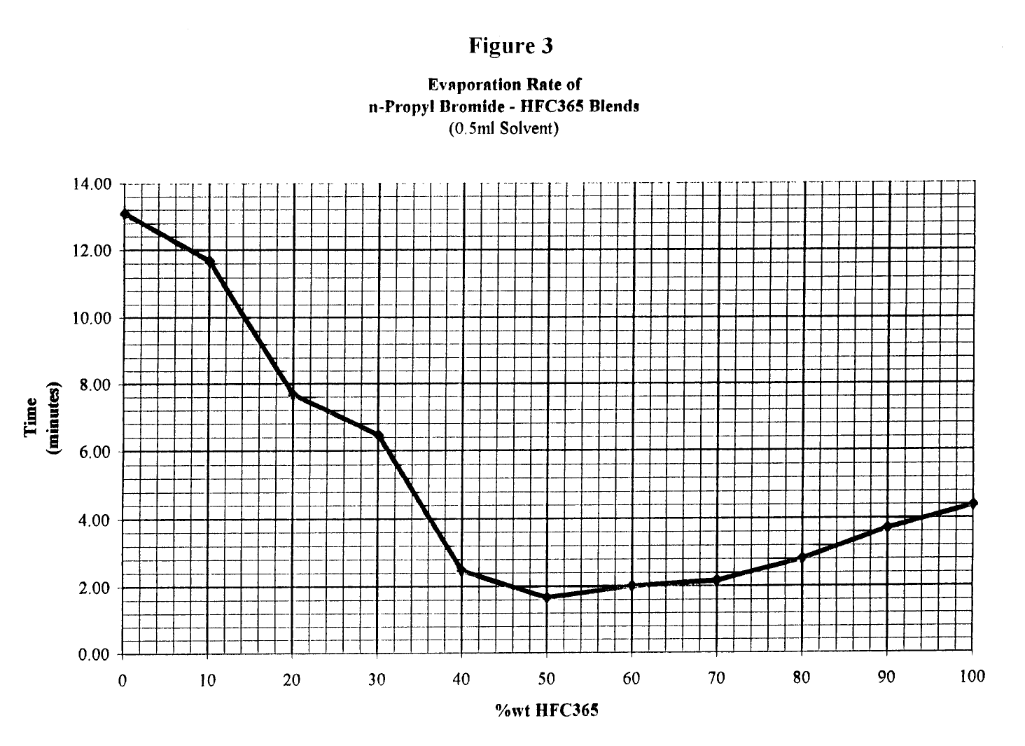

One half ml samples of various blends of n-propyl bromide and 1,1,1,3,3-pentafluorobutane were placed on a watch glass and the evaporation rate of each was measures. Table 2 below and FIG. 3 hereof, contain the data associated with these samples.

TABLE 2
Evaporation Rate of
nPB/HFC365 Blends

| % HFC365 | Time |
|---|---|
| 100 | 4.37 |
| 90 | 3.70 |
| 80 | 2.80 |
| 70 | 2.17 |
| 60 | 2.00 |
| 50 | 1.67 |
| 40 | 2.47 |
| 30 | 6.47 |
| 20 | 7.67 |
| 10 | 11.67 |
| 0 | 13.08 |

Evaporation of 1/2 ml on watch glass.
50/50 wicks up sides of glass

The above data evidences the synergistic effect towards evaporation rate of a blend of these two solvents when compared to each individually. For example, 0.5 ml of 1,1,1,3,3-pentafluorobutane (HFC365), with a boiling point of only 40.2° C., evaporates in 4.37 minutes. 0.5 ml of n-Propyl bromide which has a boiling point of 71° C., evaporates after 13.08 minutes. Surprisingly 0.5 ml of a 50:50 blend of both of these solvents evaporates in only 1.67 minutes. This is 2.6 times faster than pure 1,1,1,3,3-pentafluorobutane.

### EXAMPLE 3

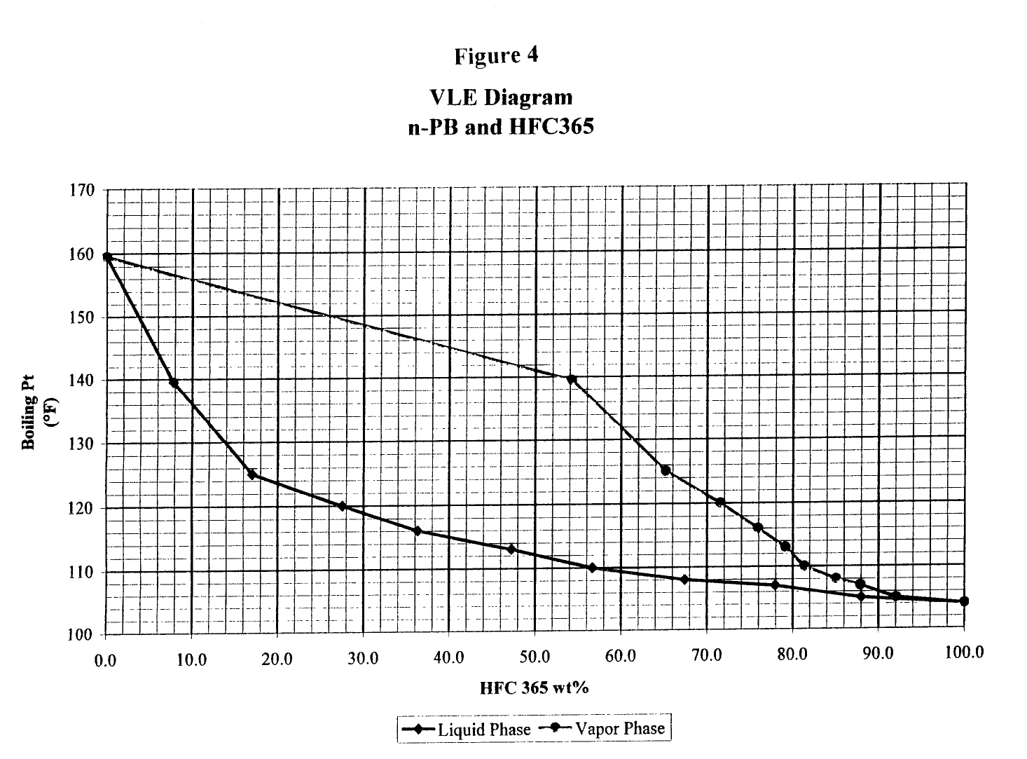

A Vapor Liquid Equilibrium (VLE) curve was generated for various mixtures of nPB and HFC365. The data for this curve is presented in Table 3 below and the curve is shown in FIG. 4 hereof. This data evidences that the various mixtures of nPB and HFC365 are non-azeotropic. That is, when a particular mixtures boils the vapor phase will have a different concentration of the two solvents than will the liquid phase.

TABLE 3

| | | HFC365 in | HFC365 in | Boiling |
|---|---|---|---|---|
| Starting Blend | | Distillate, | Liquid, | Temperature, |
| Wt. % nPB | Wt. % HFC365 | Wt. % | Wt. % | ° F. |
| 0.0 | 100.0 | 100.0 | 100.0 | 104 |
| 10.0 | 90.0 | 92.0 | 88.0 | 105 |
| 20.0 | 80.0 | 87.9 | 77.9 | 107 |
| 30.0 | 70.0 | 85.1 | 67.4 | 108 |
| 40.8 | 59.2 | 81.4 | 56.7 | 110 |
| 50.3 | 49.7 | 79.1 | 47.3 | 113 |
| 60.0 | 40.0 | 75.9 | 36.3 | 116 |
| 69.9 | 30.1 | 71.5 | 27.5 | 120 |
| 79.6 | 20.4 | 65.2 | 17.0 | 125 |
| 89.6 | 10.4 | 54.2 | 7.8 | 139.5 |
| 100.0 | 0.0 | 0.0 | 0.0 | 159.5 |

It is surprising that no azeotrope exists between these two components. We believe that one skilled in the art would expect the evaporation rate to follow the boiling point curve represented by this VLE data. One having ordinary skill in the art would also expect that a mixture with the lowest boiling point would evaporate the fastest. However, as the data indicates, unexpectedly, a minimum exists with the rate of evaporation and not in the boiling point curve.

### EXAMPLE 4

Additional experiments were carried out to determine if this phenomenon could be repeated with other solvent mixtures. The experiments were run by mixing a pair of solvents in a 50:50 ratio and measuring the diameter of the liquid spread of 10 ul of solvent on a cold rolled steel panel. Table 4 below represents some of the data obtained from these experiments. The spreadability of these various solvent blends was measured by spreading a 10 ul drop of the solvent or solvent blend on a stainless panel, then measuring its diameter after spreading. Table 4 below is a presentation of the data obtained for this example for the solvent and solvent blends indicated in the table.

TABLE 4

| | Vapor | Drop Spread | | | | |
|---|---|---|---|---|---|---|
| | Pressure A | Pure | Drop Size of 10 μl (Diameter in inches) | | | |
| Component A | (mmHg) | Component A | HFC365 | Vertrel | 141b | HFE |
| Pure | | | 0.3 | 0.4515 | 0.4205 | 0.4685 |
| Xylene | 4 | 0.468 | 1.31 | 1.491 | 1.33 | 1.2635 |
| MiBK | 4 | 0.603 | 1.268 | 1.4005 | 1.4 | 1.4 |
| Toluene | 22 | 0.405 | 1.315 | 1.342 | 1.2155 | 1.384 |
| Ethyl Acetate | 68 | 0.558 | 1.11 | 0.7615 | 0.935 | 1.055 |
| MEK | 75 | 0.466 | 1.138 | 0.938 | 0.992 | 1.214 |
| Methyl Acetate | 188 | 0.441 | 0.773 | 0.3195 | 0.8505 | 0.6165 |
| Acetone | 200 | 0.728 | 0.793 | 0.3515 | 0.812 | 0.5985 |
| Non-Flammable Materials | | | | | | |
| Perchloroethylene | 8 | 0.655 | 1.1395 | Imisible | 1.264 | 1.264 |
| Trichloroethylene | 58 | 0.666 | 1.119 | 1.0945 | 1.1045 | 1.099 |
| 111 | 102 | 0.382 | 0.9695 | 0.9055 | 0.8775 | 0.8775 |
| n-Propyl Bromide | 115 | 0.438 | 1.001 | 0.953 | 0.954 | 0.908 |
| t-Dichloroethylene | 200 | 0.375 | 0.53 | 0.534 | 0.4975 | 0.35 |
| Methylene Chloride | 350 | 0.317 | 0.312 | 0.2245 | 0.3125 | 0.3125 |

Vertrel is a trademark of Dupont a represents a family of solvents all comprising 2,3-dihydrodecafluoropentane.

141b, also known as HFC141b is a fluorocarbon, typically 1,1-dichloro-1-fluoroethane.

HFE is typically referred to as perfluoroisobutyl methyl ether.

This data evidences a direct correlation between the vapor pressure difference of the two solvents and the spreadability of the solvent mixture.

What is claimed is:

1. A solvent system for use with a coating material which solvent system is comprised of at least two organic solvents wherein the vapor pressure of at least one of the solvents is substantially different than that of at least one of the other solvents.

2. The solvent system of claim 1 wherein the vapor pressure difference is at least about 80 mm.

3. The solvent system of claim 1 wherein the solvent mixture is comprised of an effective amount of n-propyl bromide and a hydrofluorocarbon solvent.

4. The solvent system of claim 3 wherein the hydrofluorocarbon solvent is selected from the C₂ to C₅ straight or branched hydrofluorocarbon wherein at least one, but not all, of the hydrogen atoms is substituted with a fluorine atom and wherein a primary hydrogen atom can be substituted with a C₁ to C₃ alkoxy group, preferably methoxy or ethoxy.

5. The solvent system of claim 4 wherein the hydrofluorocarbon solvent is selected from the group consisting of 1,1,1,3,3-pentafluorobutane, 2,3-dihydrodecafluoropentane, and 1,1-dichloro-1-fluoroethane, methoxy-nonafluorobutane; ethoxy-nonafluorobutane, methoxy-nonafluorobutane, and ethoxy-nonafluoroisobutane.

6. The solvent system of claim 1 which is comprised of effective amounts of n-propyl bromide and 1,1,1,3,3-pentafluorobutane.

7. The solvent system of claim 6 wherein the amount of n-propyl bromide in the solvent system is from about 5 wt. % to about 95 wt. % and the amount of 1,1,1,3,3-pentafluorobutane is from about 95 wt. % to about 5 wt. %.

8. The solvent system of claim 7 wherein the amount of n-propyl bromide in the solvent system is from about 20 wt. % to about 80 wt. % and the amount of 1,1,1,3,3-pentafluorobutane is from about 80 wt. % to about 20 wt. %.

9. A coating composition for coating a solid substrate, which coating composition is comprised of: i) at least two organic solvents wherein the vapor pressure of at least one of the solvents is substantially different than that of at least one of the other solvents; and an effective amount of a coating material.

10. The coating composition of claim 9 wherein the vapor pressure difference between a first solvent and a second solvent is at least about 80 mm.

11. The coating composition of claim 10 wherein the vapor pressure difference between a first solvent and a second solvent is at least about 100 mm.

12. The solvent system of claim 11 wherein the solvent mixture is comprised of an effective amount of n-propyl bromide and a hydrofluorocarbon solvent.

13. The solvent system of claim 12 wherein the hydrofluorocarbon solvent is selected from the C₂ to C₅ straight or branched hydrofluorocarbon wherein at least one, but not all, of the hydrogen atoms is substituted with a fluorine atom and wherein a primary hydrogen atom can be substituted with a C₁ to C₃ alkoxy group, preferably methoxy or ethoxy.

14. The solvent system of claim 13 wherein the hydrofluorocarbon solvent is selected from the group consisting of 1,1,1,3,3-pentafluorobutane, 2,3-dihydrodecafluoropentane, and 1,1-dichloro-1-fluoroethane, methoxy-nonafluorobutane; ethoxy-nonafluorobutane, methoxy-nonafluorobutane, and ethoxy-nonafluoroisobutane.

15. The solvent system of claim 9 which is comprised of effective amounts of n-propyl bromide and 1,1,1,3,3-pentafluorobutane.

16. The coating composition of claim 15 wherein the amount of n-propyl bromide in the solvent system is from about 5 wt. % to about 95 wt. % and the amount of 1,1,1,3,3-pentafluorobutane is from about 95 wt. % to about 5 wt. %.

17. The coating composition of claim 16 wherein the amount of n-propyl bromide in the solvent system is from about 20 wt. % to about 80 wt. % and the amount of 1,1,1,3,3-pentafluorobutane is from about 80 wt. % to about 20 wt. %.

18. The coating composition of claim 9 wherein the coating material is selected from the group consisting of a protective oil, a lubricant, an adhesive, an ink, a paint, and a varnish.

19. The coating composition of claim 18 wherein the coating composition is a protective oil.

20. The coating composition of claim 14 wherein the coating material is selected from the group consisting of a protective oil, a lubricant, an adhesive, an ink, a paint, and a varnish.

21. The coating composition of claim 9 which also contains an effective amount of at least one additive selected from the group consisting of acid acceptors, metal passivators, stabilizing agents, and surface-active agents.

22. The coating composition of claim 15 which also contains an effective amount of at least one additive selected from the group consisting of acid acceptors, metal passivators, stabilizing agents, and surface-active agents.

23. A method for applying a coating to a solid substrate surface, which method comprises:
preparing a mixture of at least two organic solvents wherein the vapor pressure of at least one of the solvents is substantially different than that of at least one of the other solvents;
blending with said solvent mixture an effective amount of coating material to be coated onto said solid substrate surface;
applying said blend of solvent mixture and coating material to the solid substrate surface; and
evaporating said solvent mixture, thereby leaving a substantially uniform coating of said coating material on said substrate surface.

24. The coating composition of claim 21 wherein the vapor pressure difference between a first solvent and a second solvent is at least about 80 mm.

25. The coating composition of claim 22 wherein the vapor pressure difference between a first solvent and a second solvent is at least about 100 mm.

26. The solvent system of claim 23 wherein the solvent mixture is comprised of an effective amount of n-propyl bromide and a hydrofluorocarbon solvent.

27. The solvent system of claim 24 wherein the hydrofluorocarbon solvent is selected from the C₂ to C₅ straight or branched hydrofluorocarbon wherein at least one, but not all, of the hydrogen atoms is substituted with a fluorine atom and wherein a primary hydrogen atom can be substituted with a C₁ to C₃ alkoxy group, preferably methoxy or ethoxy.

28. The solvent system of claim 25 wherein the hydrofluorocarbon solvent is selected from the group consisting of 1,1,1,3,3-pentafluorobutane, 2,3-dihydrodecafluoropentane, and 1,1-dichloro-1-fluoroethane, methoxy-nonafluorobutane; ethoxy-nonafluorobutane, methoxy-nonafluorobutane, and ethoxy-nonafluoroisobutane.

29. The solvent system of claim 23 which is comprised of effective amounts of n-propyl bromide and 1,1,1,3,3-pentafluorobutane.

30. The coating composition of claim 27 wherein the amount of n-propyl bromide in the solvent system is from about 5 wt. % to about 95 wt. % and the amount of 1,1,1,3,3-pentafluorobutane is from about 95 wt. % to about 5 wt. %.

31. The coating composition of claim 28 wherein the amount of n-propyl bromide in the solvent system is from about 20 wt. % to about 80 wt. % and the amount of 1,1,1,3,3-pentafluorobutane is from about 80 wt. % to about 20 wt. %.

32. The coating composition of claim 23 wherein the coating material is selected from the group consisting of a protective oil, a lubricant, an adhesive, an ink, a paint, and a varnish.

33. The coating composition of claim 30 wherein the coating composition is a protective oil.

34. The coating composition of claim 27 wherein the coating material is selected from the group consisting of a protective oil, a lubricant, an adhesive, an ink, a paint, and a varnish.

35. The coating composition of claim 23 which also contains an effective amount of at least one additive selected from the group consisting of acid acceptors, metal passivators, stabilizing agents, and surface-active agents.

36. The coating composition of claim 27 which also contains an effective amount of at least one additive selected from the group consisting of acid acceptors, metal passivators, stabilizing agents, and surface-active agents.

37. The coating composition of claim 23 wherein the solid substrate surface is selected from the group consisting of glass, ceramic, metal, and polyermic.

38. The coating composition of claim 27 wherein the solid substrate surface is selected from the group consisting of glass, ceramic, metal, and polyermic.
